(19) United States
(12) Patent Application Publication
(10) Pub. No.: US 2020/0110742 A1
(43) Pub. Date: Apr. 9, 2020

(54) APPARATUS AND METHODS FOR USE IN HANDLING OF SEARCH QUERIES

(71) Applicant: JUST EAT HOLDING LIMITED, Borehamwood Hertfordshire (GB)

(72) Inventors: Simon POOLE, Borehamwood Hertfordshire (GB); Rob RINGROW, Borehamwood Hertfordshire (GB); Khurom KIYANI, Borehamwood Hertfordshire (GB); Alex HIGGS, Borehamwood Hertfordshire (GB); Angel JAIME, Borehamwood Hertfordshire (GB); Dave MARSLAND, Borehamwood Hertfordshire (GB)

(21) Appl. No.: 16/498,381

(22) PCT Filed: Mar. 27, 2018
(86) PCT No.: PCT/GB2018/050803

§ 371 Date: Sep. 26, 2019

(30) Foreign Application Priority Data
Mar. 27, 2017 (GB) 1704872.9

(51) Int. Cl. G06F 16/248; G06F 16/951; G06F 16/2457; G06F 16/9535; G06F 16/29; G06Q 30/02; G06F 16/2455; G06F 16/9537

(52) U.S. Cl. CPC G06F 16/248; G06F 16/951; G06F 16/24578; G06F 16/9537; G06F 16/29; G06Q 30/0206; G06F 16/2455; G06F 16/9535

(57) ABSTRACT

Disclosed herein is a method and apparatus including a server (100) comprising: (i) a data store (110) comprising a plurality of stored metrics, each associated with a corresponding one of a plurality of facilities; and a processor (120) coupled to the data store (110). The server (100) is configured to receive a metric message comprising metric data associated with an identified one of the plurality of facilities. The processor (120) is configured to provide an update of the stored metric for the identified facility based on the stored metric and the metric data, such that more recent metric data contributes more to the updated metric than less recent metric data. The server 100 is configured to respond to a request message from a User Equipment (“UE”) 301,302,303 by sending, to the UE 301,302,303, a facility message indicating a degree of prioritisation for the facilities based on the updated metrics.

### FIELD OF THE INVENTION

The present invention relates to apparatus and methods, and more particularly to methods and apparatus for use in handling of search queries in large data sets, and in a particular example to methods and apparatus for organising search results.

### BACKGROUND

As data storage has become available on a much larger scale, a server may now be configured to store vast quantities of data. Recently there has been a significant increase in the number of facilities which make themselves accessible on such servers. Accordingly, a user communicating with such a server may potentially have access to a very large number of facilities whilst having a limited ability to distinguish between them.

Previous methods for addressing this situation typically involve using data gathered from previous users of the server. This presents technical problems as data gathered from previous users may be continually uploaded to a server, and it is not clear whether the data being uploaded will be useful to help other users distinguish between the facilities accessible on the server.

For example, a user may repeatedly upload fraudulent data in order to disproportionately bias the data stored at the server. Accordingly, when a user sends a search query to the server, the results returned to said user may have been affected by such fraudulent data uploading. This may adversely affect the ability of the server to aid a user in usefully distinguishing between the facilities.

Modern fraudulent uploading behaviour is often performed in more subtle and less detectable ways. For example, by performing uploads over a longer period of time, or performing uploads more in accordance with patterns of expected user behaviour. This may lead to servers not being able to detect the fraudulent uploads.

These present technical problems associated with providing a user with targeted delivery of data, which may be of more use to the user and the specifics of their search enquiry.

### SUMMARY OF THE INVENTION

Aspects and examples of the present disclosure are set out in the claims and aim to address at least these and other technical problems.

In an aspect there is provided a server comprising a data store comprising a plurality of stored metrics, each associated with a corresponding one of a plurality of facilities, and a processor coupled to the data store. The server is configured to receive a metric message comprising metric data associated with an identified one of the plurality of facilities. The processor is configured to provide an update of the stored metric for the identified facility based on the stored metric and the metric data, such that more recent metric data contributes more to the updated metric than less recent metric data. The server is configured to respond to a request message from a User Equipment (“UE”) by sending, to the UE, a facility message indicating a degree of prioritisation for the facilities based on the updated metrics.

Embodiments may be directed to a problem of how best to organise search results. A server may receive a request message, which could be in the form of a search query. There may be a large number of possible results, for example in the form of the plurality of facilities. The server may be more useful if it provides an indication of a degree of prioritisation for the facilities. As an example, the server may provide the facilities in a suitable order based on their degree of prioritisation.

For instance, the facilities may be ordered so that the facilities with the highest degree of prioritisation are the facilities included in a facility message sent to the UE. Additionally, the facilities may be ordered so that they are the ones first seen by a user. This may be beneficial as these facilities may be the ones that are most likely to be useful to the user. For example, the stored metric may correspond to a rating of the facility and facilities with higher ratings may be more likely to be useful to a user than lower-rated facilities.

Embodiments of the present disclosure may enable the server to adapt its ordering of facilities with an increased sensitivity for temporal fluctuations. This is because updated metrics are based more heavily on recent events. For example, where the metrics correspond to ratings for a facility, these will be based more heavily on recent ratings.

Additionally, the data store may comprise a large number of facilities for which there may be little or no difference in their associated stored metrics. By determining the updated metrics with recent metric data contributing more than less recent metric data, the server may enable a user to further distinguish between facilities. For instance, where the facilities would otherwise have had similar stored metrics had all metric data contributed equally.

Recent metric data contributing more than less recent metric data may be implemented using an exponentially weighted moving average.

In an embodiment the facility message is configured to cause the UE to display a list of the facilities based on their degree of prioritisation. The facilities may be listed in an order based on their degree of prioritisation. For example, the updated metrics may represent numeric values and the highest values will be ordered first. The UE may only display a certain number of facilities, in which case, the degree of prioritisation may determine which facilities are displayed.

In an embodiment the processor is configured to determine the updated metric using a recursive estimator. The recursive estimator may be implemented as an algorithm configured to perform a recursive Bayesian filter. The processor may determine the updated metric based on a weighted combination of the stored metric and the metric data.

In an embodiment the data store may comprise a plurality of stored UE metrics, one for each UE from which the server has received a request message. The processor may be configured to provide an update of the stored UE metric for the identified facility based on the metric data and the stored UE metric. The processor is configured to determine the updated UE metric so that the more recent metric data contributes more than less recent metric data.

The processor may for example determine the update of the stored metric using the updated UE metrics and the stored metric. Here, the processor may be configured to apply a weighting to the updated UE metrics and/or the stored metric, and to determine the updated metric by combining the weighted metrics.

In an embodiment the UE comprises a first UE and the metric message is received from a second UE. For instance, the server is configured to determine a degree of prioritisation for the facilities in the facility message to be sent to a first UE based on a metric message received from a second UE. The first UE may be the same as the second UE, or they may be different. The degree of prioritisation may be determined based primarily on metric data received from the first UE. It may be based entirely on metric data received from the first UE. The server may be configured to determine an identity of the UE from which the metric message is received. The identity may be determined based on previous messages from the U E.

In an embodiment the processor is configured to determine the update based on contributions from up to a threshold quantity of metric data received from the second UE. For instance, the threshold quantity of metric data may be one. This one contribution may be the most recent metric data received from the second UE, or it may be an average of all metric data received from the second UE.

In an embodiment the processor is configured to determine the update such that the contribution from the second UE to the updated metric is limited to a threshold value. This may be implemented using the UE metrics, for instance using their weightings. The threshold value may be the same for all UEs, or it may be different. For example, certain UEs may have a higher threshold value and certain UEs may have a zero threshold value. The threshold value may be determined based on previous messages.

In an embodiment the contribution from each UE to the updated metric may include a time dependency such that UEs which have sent metric data more recently contribute more to the updated metric than UEs which have not. This may be implemented using the UE metrics, and in the form of an exponentially weighted moving average.

In an embodiment the processor is configured to determine a time bracket associated with the metric data. The time bracket may be determined based on previous messages associated with the UE. Alternatively it may be determined based on the time at which the server received the message and/or the time at which the message was sent. The processor may determine the time bracket based on pre-existing time brackets in the data store. It may store a time associated with the metric data, then the time bracket may be determined based on a time associated with a subsequent request or facility message. Time brackets may be recursive and correspond to times of day, where the times of the day may be for each day of the week. The time brackets being repeated on a daily or weekly basis.

In an embodiment the server is configured such that the stored metric corresponds to the time bracket associated with the metric data. The processor may be configured so that the degree of prioritisation is based on metrics corresponding to a time bracket associated with the request message. The metrics may be stored/updated metrics corresponding to time brackets. Alternatively, the stored/updated metrics may be stored without a corresponding time bracket and instead are only stored with a time. In such an embodiment the processor may determine the relevant time bracket and the associated metrics on-the-fly and indicate in the facility message a degree of prioritisation for the facilities based on said associated stored metrics.

In an embodiment the processor is configured to determine a geographic region associated with the metric data. The stored metrics may correspond to different geographic regions. For instance, the data store may comprise stored metrics for a plurality of geographic regions, the stored metrics being updated for metric data associated with their geographic region. The processor may be configured such that the degree of prioritisation for a facility message is based on metrics corresponding to a geographic region associated with the request message. The geographic regions may be stored and used in a manner analogous to the time brackets.

In an embodiment the request message is a search query. The search query may comprise a geographic location and/or a time. The facilities in the facility message may comprise a selection of some of the facilities. The selection may represent some, but not all, of the facilities and may be optimised for a display at a UE.

In an aspect there is provided a server comprising a data store comprising a plurality of stored metrics, each associated with a corresponding one of a plurality of facilities and a processor coupled to the data store. The server is configured to receive a metric message comprising metric data associated with an identified one of the plurality of facilities and to determine a time bracket associated with the metric data. The processor is configured to provide an update of the stored metric for the identified facility based on the stored metric, the metric data and the time bracket associated with the metric data. The server is configured to respond to a request message from a UE by sending, to the UE, a facility message indicating a degree of prioritisation for the facilities in the facility message based on the updated metrics corresponding to a time bracket associated with the request message.

In an aspect there is provided a data store comprising a plurality of stored metrics, each associated with a corresponding one of a plurality of facilities and a processor coupled to the data store. The server is configured to receive a metric message comprising metric data associated with an identified one of the plurality of facilities and to determine a geographic region associated with the metric data. The processor is configured to provide an update of the stored metric for the identified facility based on the stored metric, the metric data and the geographic region associated with the metric data. The server is configured to respond to a request message from a UE by sending, to the UE, a facility message indicating a degree of prioritisation for the facilities based on the updated metrics corresponding to a geographic region associated with the request message.

In an embodiment the processor is configured to determine the geographic region associated with the metric data based on position data received from the UE. This may be based on position data associated the metric message, for example based on position data in the metric message identifying a post code. It may also be based on position data expressed in previous messages received from the UE. It may alternatively be based on latitude and longitude coordinates, which may have been determined based on an address or from location services on the UE. The geographic region may be a distance of the user from the facility.

In an aspect there is provided a server configured to respond to a request message from a UE by sending, to the UE, a facility message configured to cause the UE to indicate a degree of prioritisation for the facilities based on the updated metrics.

In an aspect there is provided a computer implemented method comprising receiving a metric message, which may be one of a series of such messages. The metric message comprises metric data associated with one of a plurality of facilities, wherein the plurality of facilities are identified by data stored in a data store comprising a plurality of stored metrics, each associated with a corresponding one of the plurality of facilities. The method further comprises providing an update of the stored metric for the identified facility based on the stored metric and the metric data, such that more recent metric data contributes more to the updated metric than less recent metric data. The method further comprises responding to a request message from a User Equipment (“UE”) by sending, to the UE, a facility message indicating a degree of prioritisation for the facilities based on the updated metrics.

The facility message may be configured to cause the UE to display a list of the facilities based on their degree of prioritisation. The updated metric may be determined using a recursive estimator. Providing the update may comprise applying a weighting to at least one of the metric data and the stored metric.

The UE may comprise a first UE and the metric message may be received from a second UE. The degree of prioritisation for the facilities in the facility message to be sent to a first UE may be determined based on a metric message received from a second UE.

Determining the update may be based on contributions from up to a threshold quantity of metric data received from the second UE. The threshold quantity of metric data may be one. A weighting may be applied to limit the number of contributions from the second UE. The contribution from the second UE to the updated metric may be limited to a threshold value.

A time bracket may be determined which is associated with the metric data. The stored metrics may correspond to the time bracket associated with the metric data. The degree of prioritisation may be determined based on metrics corresponding to a time bracket associated with the request message.

A geographic region may be determined which is associated with the metric data. The stored metric may correspond to the geographic region associated with the metric data. The degree of prioritisation may be determined based on metrics corresponding to a geographic region associated with the request message.

The request message may be a search query, and the list of facilities to be displayed by the UE may comprises a selection of some of the facilities.

In an aspect there is provided a computer implemented method comprising receiving a metric message comprising metric data associated with an identified one of a plurality of facilities stored in a data store comprising a plurality of stored metrics, each associated with a corresponding one of the plurality of facilities. The method further comprising determining a time bracket associated with the metric data and providing an update of the stored metric for the identified facility based on the stored metric, the metric data and the time bracket associated with the metric data. The method further comprising responding to a request message from a UE by sending, to the UE, a facility message indicating a degree of prioritisation for the facilities based on the updated metrics corresponding to a time bracket associated with the request message.

The time brackets may represent times of the day. The times of day may be provided for each of the days of the week.

In an aspect there is provided a computer-implemented method comprising receiving a metric message comprising metric data associated with an identified one of a plurality of facilities stored in a data store comprising a plurality of stored metrics, each associated with a corresponding one of a plurality of facilities. The method further comprising determining a geographic region associated with the metric data and providing an update of the stored metric for the identified facility based on the stored metric, the metric data and the geographic region associated with the metric data. The method further comprising responding to a request message from a UE by sending, to the UE, a facility message indicating a degree of prioritisation for the facilities based on the updated metrics corresponding to a geographic region associated with the request message.

The geographic region may be associated with the metric data based on position data received from the UE. Determining the geographic region may be based on position data received from the UE associated with the metric data. The position data may be determined based on identifying a post code associated with the metric data.

In an aspect there is provided a computer implemented method comprising receiving a metric message, which may be one of a series of such messages. The metric message comprises metric data associated with one of a plurality of facilities, wherein the plurality of facilities are identified by data stored in a data store comprising a plurality of stored metrics, each associated with a corresponding one of the plurality of facilities. The method further comprises providing an update of the stored metric for the identified facility based on the stored metric and the metric data, such that more recent metric data contributes more to the updated metric than less recent metric data. The method further comprises responding to a request message from a User Equipment (“UE”) by sending, to the UE, a facility message configured to cause the UE to indicate a degree of prioritisation for the facilities based on the updated metrics.

In an aspect there is provided a computer implemented method comprising receiving a metric message comprising metric data associated with an identified one of a plurality of facilities stored in a data store comprising a plurality of stored metrics, each associated with a corresponding one of the plurality of facilities. The method further comprising determining a time bracket associated with the metric data and providing an update of the stored metric for the identified facility based on the stored metric, the metric data and the time bracket associated with the metric data. The method further comprising responding to a request message from a UE by sending, to the UE, a facility message configured to cause the UE to indicate a degree of prioritisation for the facilities based on the updated metrics corresponding to a time bracket associated with the request message.

In an aspect there is provided a computer-implemented method comprising receiving a metric message comprising metric data associated with an identified one of a plurality of facilities stored in a data store comprising a plurality of stored metrics, each associated with a corresponding one of a plurality of facilities. The method further comprising determining a geographic region associated with the metric data and providing an update of the stored metric for the identified facility based on the stored metric, the metric data and the geographic region associated with the metric data. The method further comprising responding to a request message from a UE by sending, to the UE, a facility message configured to cause the UE to indicate a degree of prioritisation for the facilities based on the updated metrics corresponding to a geographic region associated with the request message.

### FIGURES

Embodiments of the invention will now be described, by way of example only, with reference to the accompanying drawings in which:

FIG. 1 shows a schematic drawing of a network system.

FIG. 2 shows a timing diagram indicating a method of operation of the network system of FIG. 1.

### SPECIFIC DESCRIPTION

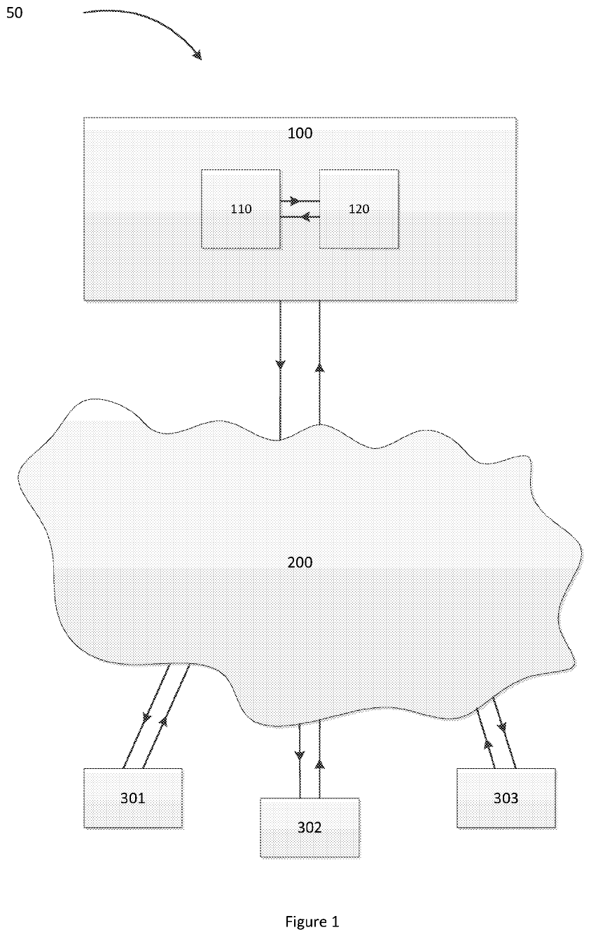

FIG. 1 shows a server configured to determine and indicate a degree of prioritisation for facilities based on metric data.

The server may be configured to receive metric data, such as user feedback for a facility, and to use it to determine an updated metric, such as overall feedback for the facility. This may in turn be used to indicate a degree of prioritisation for facilities. The updated metric may be determined using a weighting system configured so that more recent metric data is attributed a higher weighting than less recent metric data. Therefore, when determining the degree of prioritisation for the facilities, the relative contribution of more recent metric data is increased.

An update to a stored metric may impact the degree of prioritisation for the facilities. Therefore, when the server next indicates a degree of prioritisation for the facilities, it may have changed based on a recently updated metric. The extent of this change may be determined based on the amount of time elapsed since the previous update to a stored metric.

Embodiments may be directed to enable the degree of prioritisation to have an increased specificity to the user. For instance, the degree of prioritisation may be specific to a geographic location of the user. Therefore, the degree of prioritisation may be different for users in different geographic regions. Likewise, the degree of prioritisation may be specific to the time of day at which the user is communicating with the server.

The server is configured to utilise the degree of prioritisation to improve the usefulness of the facilities provided to the user. These facilities may have been selected in accordance with the geographic location of the user and/or the current time.

The network system 50 of FIG. 1 includes a server 100 comprising a data store 110 and a processor 120, a first UE 301, a second UE 302 and a third UE 303. The server 100 is coupled, via network 200, to communicate with each of the UEs. The network 200 may be a wide area network, such as the internet. The communication between the server 100 and the UEs may be provided by network messages sent over the network.

The server 100 is configured so that it may send and receive messages over the network 200 with the UEs 301,302,303. For instance the server may receive a metric message from a UE comprising metric data associated with an identified facility. The server may also receive a request message from a UE, which may be a search query, to which the server may respond by sending a facility message.

The server 100 may be configured to send and receive other messages to and/or from the UEs. For example, in response to the facility message, a user at the UE may select a facility and items offered by said facility and then send a selection message to the server indicating this selection. After this, the server 100 may send an invitation message to the UE. The invitation message may be configured to give the user the opportunity to provide metric data, such as feedback for the items from the facility. It may be in response to this invitation message that a user sends a metric message to the server 100.

The data store 110 may comprise a plurality of stored metrics, each associated with a corresponding one of a plurality of facilities. The association may be stored in the form of a data table or any other suitable data structure, which links every facility to its corresponding stored metric. In one example, each facility may represent a restaurant, and each corresponding stored metric may be a rating for the restaurant. The ratings may be updated over time based on metric data representing reviews from users of each restaurant, such that each stored metric may represent a rating for the corresponding restaurant based on the ratings from users.

The data store 110 may also comprise an association between a plurality of UE metrics and each facility. For example, each UE metric may represent a cumulative rating of the facility from one UE. Each UE metric may be based on metric messages received from one UE associated with one facility. Each metric message may relate to some items offered by the facility, and the UE metric may represent a rating that is representative of the facility as a whole, but which is based on ratings for items offered by the facility.

The data store 110 may also include an association between metric data and time brackets. Accordingly, there may be a corresponding association between stored metrics and time brackets. Each time bracket may represent a time bucket, for example Monday 9 am-11 am. The time buckets could be periodic and repeating on a daily scale, on a weekly scale, or even on longer scales. This association may be between the metric data/stored metrics and a time at which the metric data was received.

The data store 110 may also include an association between metric data and geographic regions. Accordingly, there may be a corresponding association between stored metrics and geographic regions. Each geographic region may represent an area, such as a post code, or it may represent all locations within a certain range of a given set of coordinates. This association may be between the metric data/stored metrics and a geographic location/region associated with the metric message.

The processor 120 may be configured to determine metric data associated with an identified facility from a received metric message. To do this, the processor 120 may determine the source of the metric message, which will typically be a UE, for example first UE 301. The processor 120 may retrieve previous messages associated with the first UE 301, for instance based on a reference in the metric message to a previous message from the first UE 301. From these previous messages, the processor may determine the identified facility, and also a selection of some items offered by the facility indicated in the previous messages.

The processor 120 may be configured to determine a time associated with the metric data. This may simply be identifying a time at which the message was either sent or received. Alternatively, the processor 120 may determine the time associated with the metric data based on the previous messages between the UE and the server 100. Where the previous messages indicated a purchase being made, the time associated with the metric data may be determined based on the time at which the purchase was made. Determining a time associated with the metric message may comprise determining a time bracket corresponding to the determined time.

The processor 120 may be configured to determine a geographic region associated with the metric data. The geographic region may be included in the metric message, or the processor may be configured to determine it from previous messages with the UE. For example, the previous messages may have included a search query from the UE to the server. As part of the search query a user may have specified a post code, a full address or provided a geographic location using a location feature of their UE. Determining the geographic region may comprise determining a geographic region corresponding to a received geographic location.

The processor 120 may thus have determined a UE from which the metric message was sent, an identified facility, metric data associated with the identified facility, a time bracket associated with the metric data and a geographic region associated with the metric data.

The configuration of server 100 such that the processor 120 is coupled to the data store 110 enables the processor 120 to access the data store 110 to identify stored data relevant to the determined features associated with the metric data. The relevant stored data may include the stored metric for the identified facility and the UE metric for the identified facility and UE. The processor 120 may be configured to determine an update for the stored metric, in the manner discussed below, to provide an updated metric. The processor is configured so that more recent metric data contributes more to the update.

It will be apparent to the skilled individual in the context of this disclosure that the update may be determined in a number of different ways. In one embodiment the processor 120 may provide the update using a recursive estimator. Providing the recursive estimator may include the processor 120 applying a weighting system to focus more on recent metric data, and to reduce the likelihood of any single UE having an undesirably dominant contribution to the stored metric for the identified facility.

The processor 120 may determine the updated metric based on a plurality of UE metrics, each UE metric corresponding to one UE and all of them corresponding to the identified facility. The processor 120 may then determine the updated metric using a form of rolling average of all of the UE metrics. For instance, when new metric data is received from first UE 301, the processor 120 may first determine an update for the UE metric for the first UE 301. Determining the update to the stored metric may then be based on the update to said UE metric. The processor 120 is configured to determine the update using an exponentially weighted moving average so that more recent updates to a UE metric have a greater contribution to determining the updated metric than less recent updates.

Each UE metric may be determined using a rolling weighted sum and a rolling weighted count, wherein a new UE sum value divided by a new UE count value gives the UE metric. This could be thought of as determining an effective rating for the UE. For example, where the metric data represents ratings, the UE sum represents a total of all ratings received from the UE about the facility, and the UE count represents a total number of reviews received. When determining the new UE sum and UE count values, the processor may use a time dependent factor so that the most recent metric data contributes more to the determination of the update.

As these values are determined using a recursive method, the time dependent factor may be applied to the previous UE sum and UE count values. Both the UE sum and the UE count values may also include a scaling factor configured so that each time new metric data is received, the contribution to the updated metric from a previous item of metric data is reduced. Accordingly, the more metric data is received, the less previous metric data contributes. This scaling factor may be independent of time.

The processor 120 may be configured to determine the update to the UE metric in this way to implement an exponentially weighted moving average. Additionally, the UE sum and the UE count are both scaled in the same way so that the maximum and minimum possible value for the effective rating remains constant over time.

As an example, server 100 may receive metric data representing a first rating of an identified facility by the second UE 302. The rating may be 4 out of 6. In this case the UE sum would be 4 and the UE count would be 1 so the UE metric would contribute an effective rating of 4 out of 6 to the determination of the updated metric.

At a later point in time, server 100 may receive a subsequent metric message including metric data representing a score of 1 out of 6, and so a UE sum value of 1 and a UE count value of 1. Now, the previous UE sum value of 4 would be scaled depending on the time since the previous metric data was received, and also because a subsequent item of metric data has been received. For example, this may lead to the previous UE sum value having a scaled UE sum value of 2, and the previous UE count value having a corresponding scaled UE count value of 0.5. Accordingly, the new total UE sum value would be 3 and the new UE count value would be 1.5, giving rise to a new effective rating of 2, which would be used as the contribution to the determination of the updated metric.

In an embodiment, the following algorithm may be used to determine each UE metric:

$${S}_{u} = j + {ωγ}^{Δ {d}_{1}} \cdot {S}_{u}^{′}$$

$${C}_{u} = 1 + {ωγ}^{Δ {d}_{1}} \cdot {C}_{u}^{′}$$

$${R}_{u} = \frac{{S}_{u}}{{C}_{u}}$$

### Wherein:

j is the rating determined from the metric data.
Δd₁ is the difference in time between the time associated with the most recent metric data and the previous most recent metric data for the UE.
γ is an exponentially weighted moving average decay coefficient.
ω is a scaling factor to reduce the influence of previous metric data.
Sᵤ is the new UE sum value.
Sᵤ′ is the previous UE sum value.
Cᵤ is the new UE count value.
Cᵤ′ is the previous UE count value.
Rᵤ is the new UE metric.

Due to the way the scaling of this algorithm is exponentially applied, the algorithm would produce the same results even if the metric data was processed out of order.

To implement the above-described algorithm to determine the update for a UE metric, the processor 120 is configured to retrieve, from the data store 110, previous UE sum and UE count values for the UE. Additionally, the server 100 is configured such that after the processor 120 has determined the update to the UE metric, and hence determined new UE sum and UE count values for the UE, the processor 120 is configured to store these new values, along with the time at which they were calculated, in the data store 110.

As mentioned above, the server 100 may be configured to determine the update for the stored metric using a two-step process wherein the second step comprises using the newly-determined UE metric to determine the update for the stored metric.

The processor 120 is configured to determine the update for the stored metric in a similar manner to that used to determine the update for the UE metric. However, to ensure that the contribution from the UE is limited to a threshold contribution, the processor is configured to determine the update by including a contribution from the new UE metric and removing the previous contribution the UE metric had made when determining the stored metric.

The processor 120 is configured to determine the updated metric using an exponentially weighted moving average so that recently updated UE metrics have a greater contribution to determining the updated metric than less recently updated UE metrics. The updated metric may be determined based on a rolling weighted sum and a rolling weighted count, such that a facility sum value divided by a facility count value gives the updated metric. The processor 120 may be configured to use a recursive estimator so that both the facility sum and facility count values are determined based on previous facility sum and facility count values respectively.

For example, where the UE metrics represent ratings, the facility sum value may represent a total of the ratings received from the UEs about the facility, and the facility count may represent the total number of UEs having UE metrics for the facility. Both the facility sum and the facility count may include a time dependent factor so that the most recent UE metrics contribute more to the determination of the update. This time dependent factor may be applied to the previous facility sum and facility count values.

The processor 120 may be configured so that the input for the recursive estimator is the new UE metric, the previous UE metric, the previous facility sum and facility count values and the times at which all were determined. The contribution from an updated UE metric will decay over time due to the time dependent factor. Therefore, the processor is configured to determine the contribution of the previous UE metric to the stored metric, based on the time difference between the time of determining the stored metric and the time the previous UE metric was determined. The processor 120 is configured to remove this contribution and to replace it with the contribution from the updated UE metric.

In this way, the contribution from each UE may be normalised. For example, the normalisation may be configured so that no one UE contributes more to the updated score, i.e. they all contribute the same. As with the UE scores, the time dependent factor is the same for the facility sum and facility count values.

Accordingly, for the first contribution from the UE metric to the stored metric, it will not be necessary to remove any previous values associated with that UE.

In an embodiment, the following algorithm may be used to determine an updated metric:

$${S}_{r} = {R}_{u} + ( {α}^{Δ {d}_{2}} \cdot {S}_{r}^{′} ) - {α}^{Δ {d}_{3}} \cdot {R}_{u}^{′} \\ {C}_{r} = 1 + ( {α}^{Δ {d}_{2}} \cdot {C}_{r}^{′} ) - {α}^{Δ {d}_{3}} \\ {R}_{r} = \frac{{S}_{r}}{{C}_{r}}$$

### Wherein:

Δd₂ is the time difference between the time at which the stored metric was determined and the time at which the new UE metric was determined.
Δd₃ is the time difference between the time at which the stored metric was determined and the time at which the previous UE metric was determined.
Rᵤ the new UE metric as determined above.
Rᵤ′ the previous UE metric.
Sᵣ is the new facility sum value.
Sᵣ′ is the previous facility sum value.
Cᵣ is the new facility count value.
Cᵣ′ is the previous facility count value.
α is the exponentially weighted moving average decay coefficient.
Rᵣ is the updated metric.

For the processor 120 to implement the above-described algorithm to determine the updated metric, the processor may be configured to retrieve, from the data store 110, the new UE metric, along with the previous UE metric, the previous facility sum and facility count values and the times at which all were determined. Accordingly, the server 100 is configured such that after the processor 120 has determined the updated metric, and hence the new facility sum and facility count values, the processor will store these values in the data store 110 along with the time associated with the metric data.

The configuration of server 100 such that the processor 120 may be able to use the data store 110 in the above-described manner enables updated metrics to be provided with a heightened sensitivity to recent events. In particular, this may enable the server to provide a user with a degree of prioritisation for the facilities where the facilities are prioritised based primarily on recent data, rather than being skewered by large quantities of previous data. The normalisation of the contribution of UE metrics to the updated metrics may help prevent the updated metrics being dominated by repeated contributions from only a minority of users.

The server 100 is configured such that the processor 120 may update the data store 110 accordingly after it has determined a new updated metric for the identified facility. The server 100 may then be configured to respond to a request message received from third UE 303 by sending, to the third UE 303, a facility message indicating a degree of prioritisation for the facilities based on the metrics in the data store 110 which will include the new updated metric.

The stored/updated metrics may each represent a rating for a facility, and the degree of prioritisation of these metrics may be based on the ratings. For instance, the facilities with the highest ratings may be prioritised. This prioritisation is dynamic and reflects the above nature with which the metrics are determined and hence their values changed.

The request message from the third UE 303 may be in the form of a search query, for example enquiring about facilities. The server 100 may be configured to respond by sending a facility message indicating a degree of prioritisation for the facilities. The facility message may be configured to cause the third UE 303 to display some of the facilities. This may be in the form of a selection of some of the facilities, the selection being determined based on the updated metrics. The facility message may comprise the selection of facilities, or it may provide the degree of prioritisation in the form of an order to be used by the third UE 303 to display the facilities to a user. The results of the search query may indicate the degree of prioritisation for the facilities.

The contribution from each UE metric (and thus each item of metric data received by the server 100) towards the updated metric has been described above as being normalised. Normalisation may help reduce the likelihood of repeated contributions from a single UE metric from dominating the determination of the updated metric. This normalisation may be implemented so that the contribution from each UE metric is limited to a threshold value. In some embodiments this value may differ for different UEs.

This threshold value may represent a trust factor, wherein the trust factor is configured to enable particularly trustworthy or valued UEs to have a larger impact on determining the updated metrics. Conversely, the trust factor may be configured to remove any influence that untrustworthy UEs have on determining the updated metrics.

In one embodiment, to incorporate the trust factor, the above-described algorithm for determining the updated metric may be reformulated as follows:

$${S}_{r} = ϕ \cdot {R}_{u} + ( {α}^{Δ {d}_{2}} \cdot {S}_{r}^{′} ) - {ϕ}^{′} {α}^{Δ {d}_{3}} \cdot {R}_{u}^{′}$$

$${C}_{r} = ϕ + ( {α}^{Δ {d}_{2}} \cdot {C}_{r}^{′} ) - {ϕ}^{′} {α}^{Δ {d}_{3}}$$

$${R}_{r} = \frac{{S}_{r}}{{C}_{r}}$$

Wherein the same labelling as above applies, and:
φ is the present trust factor for the UE.
φ′ is the previous trust factor for the UE, i.e. at the time the last metric message was received from the UE.

The value of the trust factor may be adjusted over time, for instance in response to trigger signals that it should be changed. For a UE which is known to be acting fraudulently and providing metric data it should not, this value could be set to 0. This has the advantage that a user at the UE who is acting fraudulently would be unaware that the processor 120 of server 100 prevents any metric data they supply from contributing to the updated metric. The processor 120 is configured so that if the trust factor is downgraded to zero, it may remove the influence of the false metric data from the updated metric. For instance, in the same manner as described above for removing the influence of previous UE scores from the same UE when determining an update for a stored metric based on new metric data.

The processor 120 may be configured to detect patterns of behaviour which may be indicative of fraudulent behaviour. It is not always clear whether a user is acting fraudulently, but the processor 120 may be configured to detect certain patterns of behaviour which are indicative of fraud. For example, where the facilities are restaurants and the metric data represents reviews of a restaurant, the following may be indicators of fraudulent behaviour: paying in cash, opting for collection rather than delivery, making low value orders, making frequent orders to the same restaurant, and leaving reviews before an order could be delivered.

The processor 120 may be configured to adjust the trust factor accordingly, so that after a few indications have been detected, its value is reduced, and as more indications are detected, the value is further reduced until reaching zero.

Conversely, a user who exhibits expected patterns of behaviour may be attributed a higher trust factor. This may be the case where such a user has engaged with a range of the facilities and has consequently been responsible for sending a large amount of metric data to the server 100. Accordingly, any metric data received from said user may be used to determine an update of the stored metrics using a large trust factor, so that their metric data has an increased contribution towards the update.

In an embodiment, metric data may be published and other users may be able to indicate whether or not they found the metric data useful. In such embodiments, trusted users may be identified where a lot of users found their metric data to be useful, and so the responsible user may be attributed a higher trust factor.

In an embodiment, the processor 120 may be configured to determine a time bracket associated with the metric data and the request message. For example, in the manner described above for the metric data. The time brackets may be used when sending the facility message to the UE so that the degree of prioritisation indicated in the facility message is representative of the time bracket of the request message.

In one embodiment, the server 100 may be configured so that the data store 110 includes a reference to the time brackets. For example each stored metric may represent a value for all time brackets, and the data store 110 may also comprise stored time metrics which correspond to stored metrics for specific time brackets. These may be stored as a sub-category for each stored metric, or they may be stored as separate metrics.

The processor 120 is configured to determine the stored time metrics in the same manner as described above for determining the updates to the stored metrics. Accordingly, an update will only be provided for a stored time metric when the metric data is associated with the time bracket of the stored time metric.

In response to receiving a request message, the processor 120 may be configured to determine the time bracket associated with the request message. Once this has been determined, the processor 120 may identify the corresponding stored time metric and send, to the UE, a facility message indicating a degree of prioritisation for the facilities based on the updated time metric corresponding to the time bracket associated with the request message.

This configuration enables facility messages to allow for fluctuations throughout the day or week in performance of a facility. For example, where the facility is a restaurant and the metrics are ratings, the server may be able to determine that the restaurant is rated poorly on Wednesday evenings, but well on Friday evenings. Accordingly, when providing a degree of prioritisation for the restaurant, the server may use a different degree of prioritisation for the different days of the week. Thus, the server 100 is configured to respond to a search query on a Wednesday evening indicating that the restaurant is not highly rated, and to respond to the same search query on a Friday evening indicating that it is highly rated.

In an embodiment, the processor 120 may be configured to determine a geographic location associated with the metric data and the request message. This may be determined in the same manner described above for the metric data. The geographic locations may be used when sending the facility message to the UE so that the degree of prioritisation indicated in the facility message is representative of a geographic region corresponding to the geographic location of the request message.

The server 100 may be configured to address the geographic regions in a manner analogous to the manner described above for time brackets.

This configuration enables facility messages to allow for fluctuations depending on locations. For example, where the facility is a restaurant which offers home delivery and the metrics are ratings, the server 100 may be able to determine that the restaurant is rated more highly when delivering to some regions rather than others. Accordingly, when providing a degree of prioritisation for the restaurant, the server may use a different degree of prioritisation for different regions.

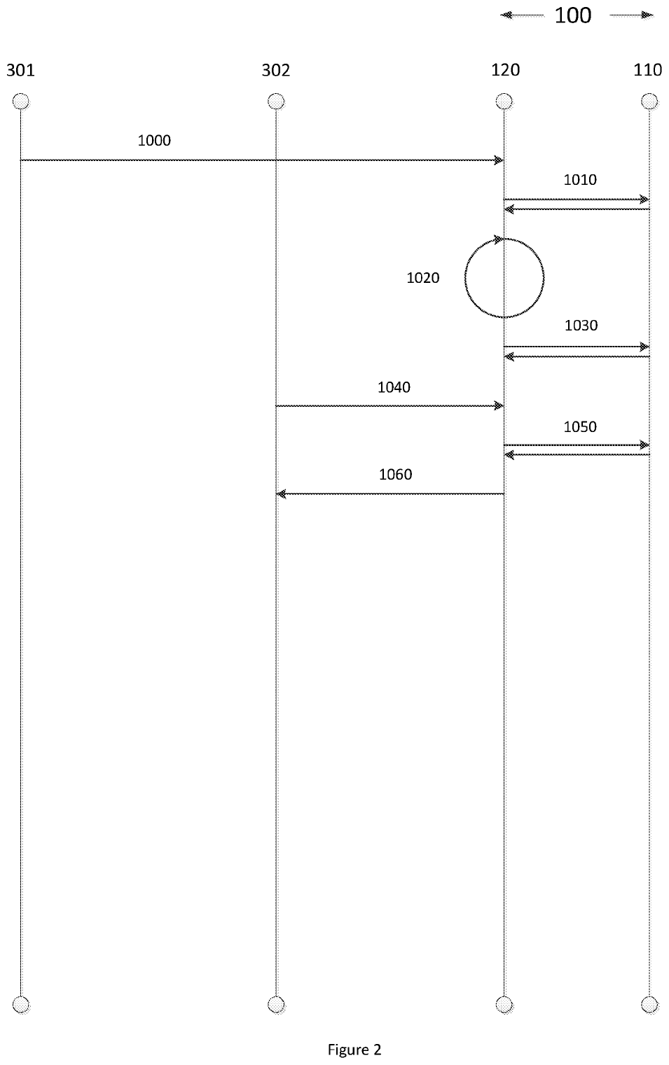

A method of operation of the network system 50 will now be described with reference to FIG. 2.

In FIG. 2, at step 1000, the first UE 301 sends a metric message comprising metric data associated with an identified one of the plurality of facilities to the server 100. In response to receiving the message, at step 1010 the processor 120 retrieves, from the data store 110, the stored metric for the identified facility. Step 1010 may also include retrieving data from previous messages with the first UE 301, which could be used to, for example, identify the facility or to identify the UE 301.

At step 1020, the processor 120 determines the update for the stored metric based on the metric data and the stored metric in the manner described above. At step 1030, the processor 120 provides the updated metric and stores it in the data store 110 along with the time associated with the metric data. The processor 120 also stores a record of the previous stored metric along with the time at which it was changed, so that this value can be used as described above.

At step 1040, the second UE 302 sends a request message to the server 100. The request message may be in the form of a search query. At step 1050, the processor 120 determines a degree of prioritisation for the facilities based on the updated metrics in the data store 110. The degree of prioritisation is determined in the manner described above. At step 1060, the server 100 sends to the second UE 302 a facility message indicating the degree of prioritisation for the facilities.

It is to be appreciated that the algorithm described above for the recursive estimator may not be the only way of implementing such a feature. For example, a recursive estimator may be used which combines the stored metric with the metric data using a pre-configured combination factor. Accordingly, it is to be understood that the UE metrics may not be necessary.

In another embodiment, all of the previous metric data may be stored in the data store so that each time new metric data is received the update may be determined using every previous item of metric data. In such an example, the processor may be configured to determine if new metric data originates from the same UE as previous metric data, and to use this determination to limit the contribution from said UE. For example, all of the metric data from said UE may be averaged, or only the most recent metric may contribute.

It is to be appreciated in the context of this disclosure that more recent metric data may not always contribute more to the updated metric than less recent metric data. For instance, when including the trust factor, it is to be appreciated that new metric data from a fraudulent reviewer may contribute less, or less recent data from a very trusted reviewer may contribute more based on the relevant trust factors.

It is to be understood in the context of this disclosure that the algorithm explained above is not limiting. For example, the algorithm may be implemented using different constants. The constants may be stored along with a date at which they apply. Therefore, any future changes made to the constants may be stored in the data store 110 along with the date the changes were made. In this way, a new algorithm is not required and instead the processor 120 will be able to perform the same calculations with the constants taking on their new values. For example such time dependent constants may be used to gradually transition to a new system, such as when implementing the above described algorithm. That way, users will not experience any sudden changes in metric data which may otherwise have occurred.

It is to be appreciated that there may be threshold values in place to determine whether or not the above-described algorithm should be used. For example, where there has been a limited amount of metric data received, any new metric data may have an undesirably dominating effect on the updated metric. In order to avoid this, minimum thresholds are implemented. These may be implemented using the facility count term, such that if this term is below a certain value the updated metric is not determined in the same way.

It is to be appreciated that the processor 120 need not determine the updated metric immediately, as the updated metric is determined using a time associated with the metric data rather than a present time, and so the result would still be the same. For example, the server may update the stored metrics on a daily basis.

It is to be appreciated that the facility message need not cause the UE to display an order of the facilities based on the degree of prioritisation. Rather, it may simply indicate them. For instance, where there is only one result to a search query, there would be no use in ordering that result, but indicating a degree of prioritisation would still be beneficial to a user.

It is to be understood in the context of this disclosure that a “user” and a “UE” may be interpreted as having similar meanings. For instance, a user may use a UE to communicate with the server. Accordingly, multiple users may use the same UE or one user may use multiple UEs. The server 100 is configured to handle either scenario. For example, the server may identify user login details as being the same, or an IP address of the UE being the same. A trust rating may then be issued to either the user or the UE, as an IP address associated with fraudulent behaviour may indicate that the UE should not be trusted, and login details associated with fraudulent behaviour may indicate that the user should not be trusted.

It is to be understood in the context of this disclosure that the UE metrics and the stored metrics may be incorporated into the same metric, or may be stored separately.

The geographic region associated with the metric data or the request message has been described above as being determined based on for example a postcode. However, this region may be determined based on a distance of the geographic location from the facility rather than a set region. This distance may be determined using a Mapping API configured so that this distance is the distance required to drive from the facility to the geographic location, rather than a straight line distance. Alternatively, the distance may be represented by a drive time, which for example, could be calculated using a Drivetime API configured to determine the estimated time it would take to drive from the facility to the geographic location at that time of day.

It is to be understood that the time brackets described above need not be a fixed pre-prescribed time bucket. Rather, these time brackets may be variable and calculated on-the-fly so they are more specific to the time associated with the request message. For example, where all of the previous metric data remains stored in the data store, the degree of prioritisation may be determined using only data points which fit within a certain time window either side of the time associated with the request message.

It is to be appreciated that the facility message may be sent to a facility rather a UE. For instance, such a facility message may be sent to alert the facility to any recent changes in their metric data. In one example, alerts may be sent to a facility in response to a change to the stored metric, or on a periodic basis so as to ensure the facility is aware of their performance. It is to be understood in the context of this disclosure that the degree of the prioritisation for the facilities being based on the updated metrics does not mean that it is based exclusively on the updated metrics, other factors may also be considered. For example, a distance of a facility from the user may also be considered. It is to be understood in the context of this disclosure that the metric data associated with an identified one of the plurality of facilities need not be all contained within the metric message. For example, the metric message may be sent in response to previous messages between the UE and the server, from which the processor may determine the identified facility or other data which may be useful to put the metric data into context.

The user equipment illustrated in FIG. 1 may be a mobile telecommunications handset, but it will be appreciated in the context of the present disclosure that this encompasses any user equipment (UE) for communicating over a wide area network and having the necessary data processing capability. It can be a hand-held telephone, a laptop computer equipped with a mobile broadband adapter, a tablet computer, a Bluetooth gateway, a specifically designed electronic communications apparatus, or any other device. It will be appreciated that such devices may be configured to determine their own location, for example using global positioning systems GPS devices and/or based on other methods such as using information from WLAN signals and telecommunications signals. The user device may comprise a computing device, such as a personal computer, or a handheld device such as a mobile (cellular) telephone or tablet. Wearable technology devices may also be used. Accordingly, the communication interface of the devices described herein may comprise any wired or wireless communication interface such as WI-FI®, Ethernet, or direct broadband internet connection, and/or a GSM, HSDPA, 3GPP, 4G or EDGE communication interface.

Messages described herein may comprise a data payload and an identifier (such as a uniform resource indicator, URI) that identifies the resource upon which to apply the request. This may enable the message to be forwarded across the network to the device to which it is addressed. Some messages include a method token which indicates a method to be performed on the resource identified by the request. For example these methods may include the hypertext transfer protocol, HTTP, methods “GET” or “HEAD”. The requests for content may be provided in the form of hypertext transfer protocol, HTTP, requests, for example such as those specified in the Network Working Group Request for Comments: RFC 2616. As will be appreciated in the context of the present disclosure, whilst the HTTP protocol and its methods have been used to explain some features of the disclosure other internet protocols, and modifications of the standard HTTP protocol may also be used.

As described herein, network messages may include, for example, HTTP messages, HTTPS messages, Internet Message Access Protocol messages, Transmission Control Protocol messages, Internet Protocol messages, TCP/IP messages, File Transfer Protocol messages or any other suitable message type may be used.

The processor 120 of the server 100 (and any of the activities and apparatus outlined herein) may be implemented with fixed logic such as assemblies of logic gates or programmable logic such as software and/or computer program instructions executed by a processor. Other kinds of programmable logic include programmable processors, programmable digital logic (e.g., a field programmable gate array (FPGA), an erasable programmable read only memory (EPROM), an electrically erasable programmable read only memory (EEPROM)), an application specific integrated circuit, ASIC, or any other kind of digital logic, software, code, electronic instructions, flash memory, optical disks, CD-ROMs, DVD ROMs, magnetic or optical cards, other types of machine-readable mediums suitable for storing electronic instructions, or any suitable combination thereof. Such data storage media may also provide the data store of the server 100 (and any of the apparatus outlined herein).

It will be appreciated from the discussion above that the embodiments shown in the Figures are merely exemplary, and include features which may be generalised, removed or replaced as described herein and as set out in the claims. With reference to the drawings in general, it will be appreciated that schematic functional block diagrams are used to indicate functionality of systems and apparatus described herein. For example the functionality provided by the data store may in whole or in part be provided by a processor having one more data values stored on-chip. In addition the processing functionality may also be provided by devices which are supported by an electronic device. It will be appreciated however that the functionality need not be divided in this way, and should not be taken to imply any particular structure of hardware other than that described and claimed below. The function of one or more of the elements shown in the drawings may be further subdivided, and/or distributed throughout apparatus of the disclosure. In some embodiments the function of one or more elements shown in the drawings may be integrated into a single functional unit.

The above embodiments are to be understood as illustrative examples. Further embodiments are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

In some examples, one or more memory elements can store data and/or program instructions used to implement the operations described herein. Embodiments of the disclosure provide tangible, non-transitory storage media comprising program instructions operable to program a processor to perform any one or more of the methods described and/or claimed herein and/or to provide data processing apparatus as described and/or claimed herein.

Certain features of the methods described herein may be implemented in hardware, and one or more functions of the apparatus may be implemented in method steps. It will also be appreciated in the context of the present disclosure that the methods described herein need not be performed in the order in which they are described, nor necessarily in the order in which they are depicted in the drawings. Accordingly, aspects of the disclosure which are described with reference to products or apparatus are also intended to be implemented as methods and vice versa. The methods described herein may be implemented in computer programs, or in hardware or in any combination thereof. Computer programs include software, middleware, firmware, and any combination thereof. Such programs may be provided as signals or network messages and may be recorded on computer readable media such as tangible computer readable media which may store the computer programs in not-transitory form. Hardware includes computers, handheld devices, programmable processors, general purpose processors, application specific integrated circuits, ASICs, field programmable gate arrays, FPGAs, and arrays of logic gates.

Other examples and variations of the disclosure will be apparent to the skilled addressee in the context of the present disclosure.

1. A server comprising:
a data store comprising a plurality of stored metrics, each associated with a corresponding one of a plurality of facilities; and
a processor coupled to the data store;
the server is configured to receive a metric message comprising metric data associated with an identified one of the plurality of facilities;
the processor is configured to provide an update of the stored metric for the identified facility based on the stored metric and the metric data, such that more recent metric data contributes more to the updated metric than less recent metric data; and
the server is configured to respond to a request message from a User Equipment (“UE”) by sending, to the UE, a facility message indicating a degree of prioritisation for the facilities based on the updated metrics.

2. The server of claim 1 wherein the facility message is configured to cause the UE to display a list of the facilities based on their degree of prioritisation.

3. The server of any one of the preceding claims wherein the processor is configured to determine the updated metric using a recursive estimator.

4. The server of claim 3 wherein providing the update comprises applying a weighting to at least one of the metric data and the stored metric.

5. The server of any one of the preceding claims wherein the UE comprises a first UE and the metric message is received from a second UE.

6. The server of any one of claims 1 to 4 wherein the server is configured to determine the degree of prioritisation for the facilities in the facility message to be sent to a first UE based on a metric message received from a second UE.

7. The server of either one of claim 5 or 6 wherein the processor is configured to determine the update based on contributions from up to a threshold quantity of metric data received from the second U E.

8. The server of claim 7 wherein the threshold quantity of metric data is one.

9. The server of either one of claim 7 or 8, as dependent on claim 4, wherein the processor is configured to apply the weighting to limit the number of contributions from the second UE.

10. The server of either one of claim 5 or 6 wherein the processor is configured so that the contribution from the second UE to the updated metric is limited to a threshold value.

11. The server of any one of the preceding claims wherein the processor is configured to determine a time bracket associated with the metric data.

12. The server of claim 11 wherein the server is configured such that the stored metric corresponds to the time bracket associated with the metric data.

13. The server of either one of claim 11 or 12 wherein the processor is configured such that the degree of prioritisation is based on metrics corresponding to a time bracket associated with the request message.

14. The server of any one of claims 6 to 9 wherein the processor is configured to determine a geographic region associated with the metric data.

15. The server of claim 14 wherein the stored metric corresponds to the geographic region associated with the metric data.

16. The server of either one of claim 14 or 15 wherein the processor is configured such that the degree of prioritisation is based on metrics corresponding to a geographic region associated with the request message.

17. The server of any one of the preceding claims wherein the request message is a search query.

18. The server of claim 2 wherein the list of facilities to be displayed by the UE comprises a selection of some of the facilities.

19. A server comprising:
a data store comprising a plurality of stored metrics, each associated with a corresponding one of a plurality of facilities; and
a processor coupled to the data store;
the server is configured to receive a metric message comprising metric data associated with an identified one of the plurality of facilities and to determine a time bracket associated with the metric data;
the processor is configured to provide an update of the stored metric for the identified facility based on the stored metric, the metric data and the time bracket associated with the metric data; and
the server is configured to respond to a request message from a UE by sending, to the UE, a facility message indicating a degree of prioritisation for the facilities based on the updated metrics corresponding to a time bracket associated with the request message.

20. The server of claim 19 wherein the server is configured such that time brackets represent times of the day.

21. The server of claim 20 wherein the times of day are provided for each of the days of the week.

22. A server comprising:
a data store comprising a plurality of stored metrics, each associated with a corresponding one of a plurality of facilities; and
a processor coupled to the data store;
the server is configured to receive a metric message comprising metric data associated with an identified one of the plurality of facilities and to determine a geographic region associated with the metric data;
the processor is configured to provide an update of the stored metric for the identified facility based on the stored metric, the metric data and the geographic region associated with the metric data; and
the server is configured to respond to a request message from a UE by sending, to the UE, a facility message indicating a degree of prioritisation for the facilities based on the updated metrics corresponding to a geographic region associated with the request message.

23. The server of claim 22 wherein the processor is configured to determine the geographic region associated with the metric data based on position data received from the UE.

24. The server of claim 23 wherein the processor is configured to determine the position data received from the UE based on the metric data.

25. The server of claim 24 wherein the processor is configured to determine the position data based on identifying a post code associated with the metric data.

26. A server comprising:
a data store comprising a plurality of stored metrics, each associated with a corresponding one of a plurality of facilities; and
a processor coupled to the data store;
the server is configured to receive a metric message comprising metric data associated with an identified one of the plurality of facilities;
the processor is configured to provide an update of the stored metric for the identified facility based on the stored metric and the metric data such that more recent metric data contributes more to the updated metric than less recent metric data; and
the server is configured to respond to a request message from a UE by sending, to the UE, a facility message configured to cause the UE to indicate a degree of prioritisation for the facilities based on the updated metrics.

27. A server comprising:
a data store comprising a plurality of stored metrics, each associated with a corresponding one of a plurality of facilities; and
a processor coupled to the data store;
the server is configured to receive a metric message comprising metric data associated with an identified one of the plurality of facilities and to determine a time bracket associated with the metric data;
the processor is configured to provide an update of the stored metric for the identified facility based on the stored metric, the metric data and the time bracket associated with the metric data; and
the server is configured to respond to a request message from a UE by sending, to the UE, a facility message configured to cause the UE to indicate a degree of prioritisation for the facilities based on the updated metrics corresponding to a time bracket associated with the request message.

28. A server comprising:
a data store comprising a plurality of stored metrics, each associated with a corresponding one of a plurality of facilities; and
a processor coupled to the data store;
the server is configured to receive a metric message comprising metric data associated with an identified one of a plurality of facilities and to determine a geographic region associated with the metric data;
the processor is configured to provide an update of the stored metric for the identified facility based on the stored metric, the metric data and the geographic region associated with the metric data; and
the server is configured to respond to a request message from a UE by sending, to the UE, a facility message configured to cause the UE to indicate a degree of prioritisation for the facilities based on the updated metrics corresponding to a geographic region associated with the request message.

29. A computer-implemented method comprising:
receiving a metric message comprising metric data associated with an identified one of a plurality of facilities;
providing an update of a stored metric for the identified facility based on the stored metric and the metric data, such that more recent metric data contributes more to the updated metric than less recent metric data; and
responding to a request message from a User Equipment (“UE”) by sending, to the UE, a facility message indicating a degree of prioritisation for the facilities based on the updated metrics.

30. A computer program product comprising program instructions configured to program a processor to perform the method of claim 29.
